(19) United States
(12) Patent Application Publication
(10) Pub. No.: US 2026/0018154 A1
(43) Pub. Date: Jan. 15, 2026

(54) ASSEMBLY OF ACOUSTIC COMPONENT SECTORS

(71) Applicant: SAFRAN, PARIS (FR)

(72) Inventors: Nicolas Pierre LANFANT, MOISSY-CRAMAYEL (FR); Hugues Laurent ALGLAVE, MOISSY-CRAMAYEL (FR); Patrick DUNLEAVY, MOISSY-CRAMAYEL (FR)

(21) Appl. No.: 18/880,038

(22) PCT Filed: Jun. 21, 2023
(86) PCT No.: PCT/FR2023/050935

§ 371 Date: Dec. 30, 2024

(30) Foreign Application Priority Data
Jun. 29, 2022 (FR) 2206532

(51) Int. Cl. G10K 11/172; B64D 33/04; G10K 11/16

(52) U.S. Cl. CPC G10K 11/172; G10K 11/161; B64D 33/06

(57) ABSTRACT

There is provided an assembly of annular sectors of an annular multi-element acoustic component, each sector including a plurality of rows of hollow complex acoustic elements each having a shape that steadily narrows between a base and a vertex, each sector including a plurality of first rows including the same number of hollow complex elements and one or more second rows including one less hollow complex element than the first rows, each second row further including a male attachment element on one of the assembly edges and a female attachment element on the other assembly edge, the female attachment element having the same dimension as a hollow complex element along the direction of assembly.

### TECHNICAL FIELD

The present invention relates to the general field of acoustic structures or panels. More particularly, but not exclusively, it concerns acoustic attenuation structures used to reduce noise produced in aircraft engines as well as in gas turbines or exhaust thereof.

### PRIOR ART

Acoustic attenuation structures typically consist of a plate or skin with an acoustic surface permeable to the acoustic waves that it is desired to attenuate and of a reflective solid plate or skin called a “closing plate”, a multi-element acoustic component and a multicellular body being disposed between these two walls. The multicellular body is generally composed of a set of partitions, for example in the form of a honeycomb, and the multi-element acoustic component generally comprises hollow complex acoustic elements, for example cones, arranged in the cells of the multicellular body. In a well-known manner, such structures form resonators of the Helmholtz type which make it possible to attenuate the acoustic waves in a certain range of frequencies. Acoustic attenuation structures of this type are especially described in the document FR 3 108 765 A1.

In most applications of such acoustic structures, for example in aeronautics, the multi-element acoustic component must be lightweight in order to limit the mass of the acoustic structure. In order to produce a lightweight multi-element acoustic component, it is necessary to use manufacturing methods that allow the production of very thin walls, such as, for example, injection molding or stamping at controlled temperature and pressure. However, such methods require special tools and parameters, which limit the size of the multi-element acoustic components that can be obtained by these methods.

Acoustic structures may be intended to cover the inner or outer annular surface of large parts or elements, for example a fan casing of an aircraft engine. Thus, it is necessary to produce the multi-element acoustic component in several annular sectors, then to assemble said multi-element acoustic component sectors on the surface to be covered by mounting them with the multicellular body and the acoustic skin, so as to form an annular acoustic structure conforming to the surface to be covered.

Fasteners are used to bond the different sectors of the multi-element acoustic component along the perimeter of the surface to be covered.

However, the design, positioning and assembly of the various pieces of the acoustic structure can be tricky.

First of all, the fasteners used increase the mass of the acoustic structure and generally represent areas that do not participate in acoustic attenuation. In addition, the fasteners used can have an aerodynamic impact by disrupting the airflow.

The positioning of the various pieces of the acoustic structure with respect to one another along the perimeter of the surface to be covered can also be complex, in particular when the hollow acoustic elements or cells have a hexagonal shape. In fact, as illustrated in FIG. 1, clearances may be present between the various pieces of acoustic structure. These clearances represent areas not covered by the acoustic assembly, which will therefore not be able to perform their acoustic attenuation function. Furthermore, without special provisions, the assembly edges between the different sectors may not be complementary, and thus cause additional uncovered areas, as illustrated in FIG. 1.

In addition, the uncovered areas also create discontinuities in the acoustic treatment, which will modify the structure of the acoustic field by repelling the energy that propagates in the annular acoustic structure. Thus, the decrease in acoustic performance is much greater than the decrease in performance due solely to the loss of acoustic functional surface area.

Conversely, it may be necessary to cut out pieces of the acoustic structure during assembly to avoid unwanted overlaps between sectors and thus allow assembly. These cut outs are a waste of material and lead to unnecessary costs.

Finally, uncovered areas and overlaps can decrease the aerodynamic performance of the acoustic structure, by disrupting the airflow and increasing the drag of the acoustic structure.

### DISCLOSURE OF THE INVENTION

The main object of the present invention is therefore to enable the assembly of acoustic structures while avoiding at least some of the abovementioned issues.

To this end, the invention proposes an annular sector of an annular multi-element acoustic component extending along a direction of assembly between a first assembly edge and a second assembly edge opposite the first assembly edge, the sector comprising a plurality of rows of hollow complex acoustic elements each having a shape that steadily narrows between a base and a vertex, the hollow complex elements being connected to each other by one or more adjacent edges, each row extending from the first to the second assembly edge along the direction of assembly, said sector being characterized in that it comprises a plurality of first rows comprising the same number of hollow complex acoustic elements and one or more second rows comprising one less hollow complex element than the first rows, each second row further comprising a male attachment element on one of the assembly edges and a female attachment element on the other assembly edge, the female attachment element having the same dimension as a hollow complex element along the direction of assembly.

By using annular sectors whose first rows have the same number of hollow acoustic elements and whose second rows comprising the male and female attachment elements have one less hollow acoustic element than the first rows, it is ensured that annular sectors are produced whose first assembly edge is complementary to the second assembly edge. In addition, by using a female attachment element having the same dimension as a hollow complex element along the direction of assembly, it is ensured that the area occupied by the assembly of a female attachment element with a male attachment element fits perfectly between two adjacent sectors, without altering the complementarity between the edges of said sectors.

In addition, it is no longer necessary to provide an area for the assembly of two neighboring sectors since this function is performed by the attachment elements. Thus, the surface area actually devoted to acoustic attenuation is increased compared to the acoustic structures of the prior art not comprising such attachment elements.

According to a particular embodiment of the invention, the male attachment element has a pierced shape that steadily narrows between a base and a vertex.

Thus, the areas that do not effectively participate in acoustic attenuation are further limited because of the assembly of the sectors, the male attachment element being capable of fulfilling an acoustic attenuation function. More particularly, the male attachment element preferably has a geometrical shape identical to that of the hollow complex acoustic elements.

According to another particular embodiment of the invention, the bases of the hollow complex acoustic elements are hexagonal.

Assembling a multi-element acoustic component comprising hexagonal hollow complex acoustic elements is more difficult than in the case of square hollow acoustic elements. Thus, the sectors according to the invention are particularly interesting in the case of hexagonal hollow complex acoustic elements.

The invention further concerns an annular multi-element acoustic component comprising the assembly of a plurality of annular sectors according to the invention along the direction of assembly, each male attachment element of an annular sector of the acoustic component being inserted into a female attachment element of an adjacent sector.

The positioning of the sectors relative to one another is thus facilitated, the attachment elements serving as reference points for the assembly of the sectors relative to one another. In addition, the space occupied by the attachment elements is limited and fits perfectly into the assembly between the hollow complex acoustic elements of the different sectors.

According to a particular embodiment of the invention, all the sectors are identical.

“Identical sectors” means that each sector has the same dimensions, the same shape of hollow complex acoustic elements, the same number of rows of hollow complex acoustic elements, the same number of hollow acoustic elements in each first and second row, the same offset between rows of hollow complex acoustic elements, the same shape of attachment elements and the same positioning of attachment elements.

Thus, the design and manufacture of the sectors is greatly simplified, and consequently the design and manufacture of the complete acoustic structure is facilitated.

The invention also concerns an annular acoustic attenuation structure comprising an annular multi-element acoustic component according to the invention and an annular multicellular body, the vertex of each hollow complex acoustic element of the multi-element acoustic component being inserted into a cell of the multicellular body.

Preferably, the assembly of the male attachment element with the female attachment element is present in a volume comprised between the surface defined by the bases or edges of the hollow complex acoustic elements and the surface defined by the vertices of the hollow complex acoustic elements. Thus, the assembly of the male element with the female element does not generate any excess thickness, which makes it possible not to alter the aerodynamics of the multi-element acoustic component and to facilitate the assembly of said multi-element acoustic component with an optional multicellular body or an optional acoustic skin.

According to a particular embodiment of the invention, the acoustic attenuation structure further comprises a perforated acoustic skin, said acoustic skin being in contact with the base of the hollow complex acoustic elements.

According to another particular embodiment of the invention, the annular multicellular body comprises a plurality of annular sectors of assembled multicellular bodies extending along the direction of assembly, the length of the annular sectors of the multicellular body being greater than the length of the annular sectors of the multi-element acoustic component along the direction of assembly.

Indeed, the manufacturing and assembly of the multicellular body present fewer constraints than the manufacturing and assembly of the multi-element acoustic component because the manufacturing and assembly tolerances of the multicellular body are less strict than those of the multi-element acoustic component. Thus, in order to limit the number of fastenings or manipulations to form the multicellular body, it is sought to assemble a limited number of sectors of multicellular bodies. In addition, by using multicellular body sectors longer than the multi-element acoustic component sectors the robustness of the acoustic structure assembly is increased.

The invention also concerns a method for designing an annular multi-element acoustic component according to the invention, said annular multi-element acoustic component extending around an axial direction and having a defined inner or outer cross-sectional perimeter, each annular acoustic component sector extending along the axial direction between a first circumferential edge and a second circumferential edge, the circumferential edges extending along the direction of assembly, the method comprising the following steps:
determining a number of annular sectors of the multi-element acoustic component by rounding to the next integer the ratio of the perimeter of the cross-section of said acoustic component to the maximum theoretical length of an annular sector of a multi-element acoustic component;
determining the length of the circumferential edges of each annular sector of the acoustic component;
determining a theoretical width along the direction of assembly of the hollow complex acoustic elements corresponding to the desired acoustic attenuation;
determining a whole number of hollow complex acoustic elements per first row of each annular sector;
determining a final width along the direction of assembly of the hollow complex acoustic elements.

Thus, the design method according to the invention makes it possible to produce multi-element acoustic components that assemble easily and with a very small clearance between the sectors. Indeed, the invention proposes to slightly adjust the width of the hollow acoustic elements to limit the clearance between the sectors, which ultimately improves the acoustic properties of the annular multi-element acoustic component by reducing the non-functional areas and limiting discontinuities in the acoustic field. In addition, by ensuring a constant number of hollow complex elements per row, complementary axial edges are obtained at the junction between the annular sectors.

Finally, the invention proposes a method of manufacturing an annular acoustic attenuation structure comprising:
designing an annular multi-element acoustic component as described above;
producing the annular sectors of said multi-element acoustic component in accordance with the design;
assembling the annular sectors of the multi-element acoustic component with each other and with an annular multicellular body, so that each hollow complex acoustic element is arranged in a cell of the multicellular body;
covering the multi-element acoustic component with an acoustic skin so as to form the annular acoustic attenuation structure comprising at least the annular multi-element acoustic component, the annular multicellular body and the acoustic skin.

### BRIEF DESCRIPTION OF THE DRAWINGS

FIG. 1 schematically illustrates the assembly of an annular acoustic structure around a cylindrical element without the invention.

FIG. 2 is a partial exploded perspective view of an acoustic structure according to an embodiment of the invention comprising a multi-element acoustic component.

FIG. 3 is a perspective view of a sector of the multi-element acoustic component of FIG. 2 comprising attachment elements according to one embodiment of the invention.

FIG. 4 is a sectional view of two acoustic component sectors assembled according to a first variant.

FIG. 5 is a sectional view of two acoustic component sectors assembled according to a second variant.

FIG. 6 is a perspective view of the assembly of a different multi-element acoustic component than the one shown in FIG. 1.

FIG. 7 is a flowchart describing the method of designing a multi-element acoustic component according to one embodiment of the invention.

FIG. 8 schematically illustrates the steps of the design method of FIG. 7.

FIG. 9 is a schematic partial sectional view of the assembled acoustic structure of FIG. 2.

### DESCRIPTION OF THE EMBODIMENTS

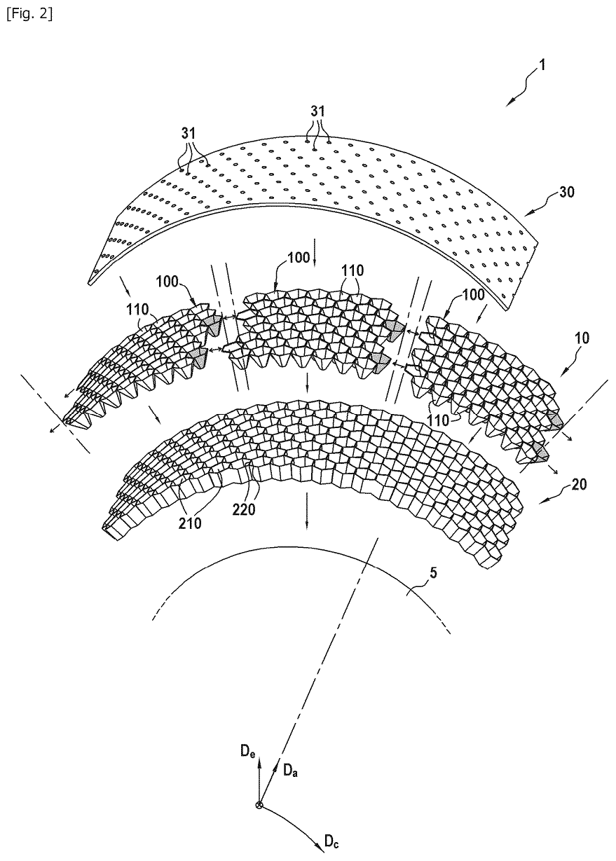

FIG. 2 illustrates the assembly of an acoustic structure 1 according to the invention on the developable outer surface of an annular part 5 of large dimension extending around an axial direction Dₐ. Naturally, it would not exceed the scope of the invention if the acoustic structure according to the invention were assembled on the developable inner surface of a large annular part 5.

The annular part 5 may, for example, be a fan casing of a jet engine, an aircraft turbojet nacelle, a fuselage element, a wing element, a platform connecting the vanes of a stator or an inner flow spacer (IFS).

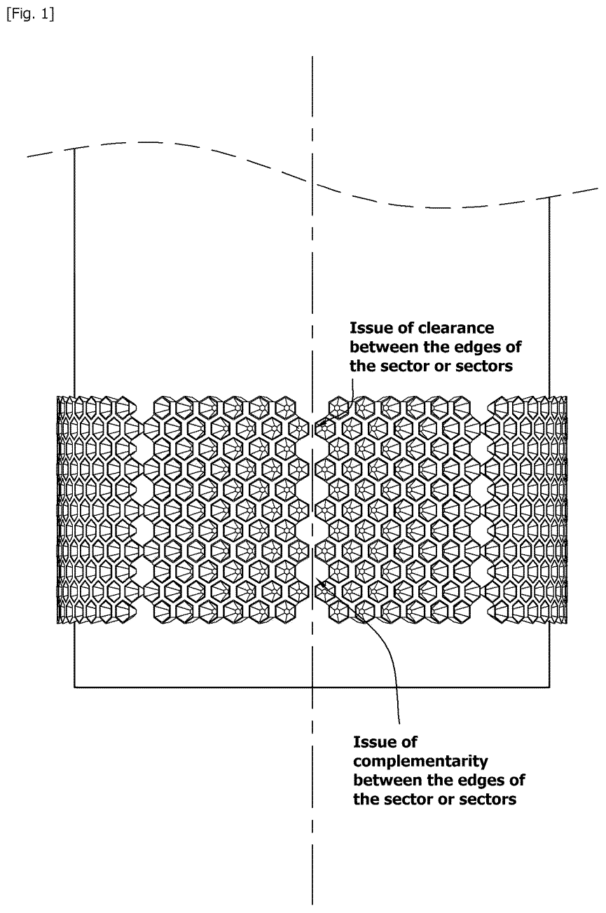

The term “annular” here describes a shape comprising at least one developable inner or outer surface extending around the axial direction Dₐ and making a complete revolution around said axial direction Dₐ, and having a constant cross-section in each plane perpendicular to said axial direction Dₐ. Thus, the term “annular” can describe, for example, a shape having a cylindrical surface of revolution, as illustrated in FIGS. 1 to 9.

The annular acoustic structure 1 comprises at least one annular multi-element acoustic component 10 and an annular multicellular body 20. The annular multicellular body 20 and the annular multi-element acoustic component 10 each extend around the axial direction Dₐ along a circumferential direction of assembly D_{c}. The multicellular body 20 comprises a plurality of cells 210 distributed in rows and separated by partitions 220 which form an array of ribs. The multicellular body 20 is preferably in contact with the surface to be covered of the part 5. The annular multi-element acoustic component 10 comprises a plurality of hollow complex acoustic elements 110 distributed in rows. In a well-known manner, the annular multi-element acoustic component 10 is inserted into the annular multicellular body 20 so that each hollow complex acoustic element 110 of the multi-element acoustic component 10 is inserted into a cell 210 of the multicellular body 20.

Preferably, the acoustic structure 1 also comprises an acoustic skin 30 which covers the annular multi-element acoustic component 10. The function of the acoustic skin 30 is to allow the sound waves to be attenuated to pass through the inside of the acoustic structure 1. To this end, the acoustic skin 30 comprises a plurality of perforations 31.

The annular multi-element acoustic component 10 is produced by assembling a plurality of annular sectors 100 of the annular multi-element acoustic component 10. Preferably, the annular multi-element acoustic component 10 is mounted sector by sector in the annular multicellular body 20.

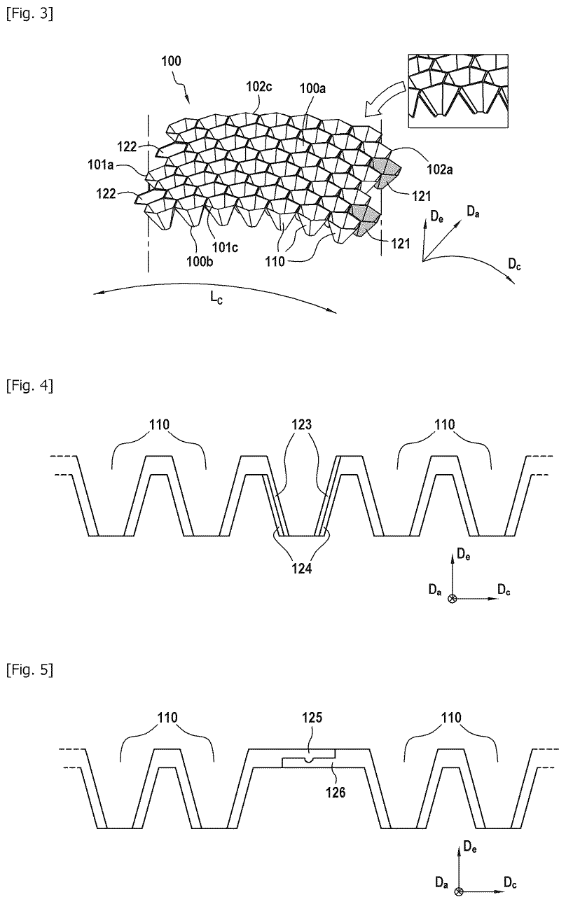

FIG. 3 illustrates an example of an annular sector 100 of an annular multi-element acoustic component 10.

The annular sector 100 extends along the circumferential direction of assembly D_{c} between a first assembly edge 101a and a second assembly edge 102a opposite the first assembly edge 101a. The first assembly edge 101a of the annular sector 100 is intended to be assembled with the second assembly edge of an adjacent annular sector, and the second assembly edge 102a of the annular sector 100 is intended to be assembled with the first assembly edge of an adjacent annular sector. The annular sector 100 also extends in the axial direction Dₐ between a first circumferential edge 101c and a second circumferential edge 102c. The first circumferential edge 101c and a second circumferential edge 102c preferably have the same length L_{c}.

The annular sector 100 of the annular multi-element acoustic component 10 comprises a plurality of hollow complex acoustic elements 110 distributed in rows. Each row of hollow acoustic elements 110 extends along the circumferential direction of assembly D_{c} from the first assembly edge 101a to the second assembly edge 102a of the annular sector 100. The hollow complex acoustic elements each have a shape that steadily narrows between a base and a vertex, the hollow acoustic elements being connected to each other by one or more adjacent edges. The hollow complex acoustic elements have, for example, the shape of a pierced truncated cone or a pierced truncated pyramid, as illustrated in FIGS. 2 to 9. The base of each complex acoustic element 110 is in continuous contact with the base of the adjacent complex acoustic elements 110 so as to form a continuous array of edges.

The annular sector 100 extends in thickness in a thickness direction Dₑ perpendicular to the axial direction Dₐ and to the circumferential direction of assembly D_{c}, between an upper surface 100a and a lower surface 100b. The upper surface 100a is defined by the bases of the hollow acoustic elements 110 and the lower surface 100b is defined by the vertices of the hollow acoustic elements 110. The upper surface 100a consequently has a length L_{c} along the circumferential direction of assembly D_{c}.

The annular sector 100 of annular multi-element acoustic component 10 comprises a plurality of first rows of hollow acoustic elements 110 having the same number n of hollow acoustic elements 110. In the example illustrated in FIG. 3, the number n of hollow acoustic elements 110 of each first row is seven. The annular sector 100 of the annular multi-element acoustic component 10 further comprises one or more second rows of hollow acoustic elements 110 having one less hollow acoustic element 110 than the first rows, that is to say the second row or rows of hollow acoustic elements 110 have the same number n−1 of hollow acoustic elements 110. In the example illustrated in FIG. 3, the number n−1 of hollow acoustic elements 110 of each second row is six.

Each second row of hollow acoustic elements 110 further comprises a male attachment element 121 on one of the assembly edges 101a or 102a of the annular sector 100 and a female attachment element 122 on the other assembly edge 101a or 102a of the annular sector 100. In the example illustrated in FIG. 3, the sector 100 comprises 8 rows of hollow acoustic elements 110, of which 6 are first rows and 2 are second rows.

The male attachment element 121 of the annular sector 100 is intended to cooperate with the female attachment element of an adjacent annular sector, and the female attachment element 122 of the annular sector 100 is intended to cooperate with the male attachment element of an adjacent annular sector. A male attachment element cooperates with a female attachment element by inserting the male attachment element into the female attachment element. The cooperation of a male attachment element of an annular sector of the multi-element acoustic component 10 with a female attachment element of an adjacent annular sector of the multi-element acoustic component 10 secures said annular sector to the adjacent annular sector.

The female attachment element 122 has the same dimension along the circumferential direction of assembly D_{c} as a hollow complex acoustic element 110. Thus, the annular sectors can be positioned with regard to one another without leaving areas not covered by a hollow complex acoustic element 100 or by a female attachment element 122, the female attachment element 122 in which a male attachment element is inserted completely filling the area between two adjacent annular sectors.

Preferably, in order that the areas covered by the female attachment elements 122 in which male attachment elements are inserted are not lost and can perform an acoustic attenuation function, the male attachment elements 121 have a shape similar to that of the hollow complex acoustic elements 110, as illustrated in FIGS. 2 and 3. Thus, the male elements 121 have a pierced shape that steadily narrows between a base and a vertex, the base of the male elements 121 being located on the same side of the annular sector 100 as the bases of the hollow complex acoustic elements 110 and the vertex of the male attachment elements 121 being located on the same side of the annular sector 100 as the vertices of the hollow complex acoustic elements 110. Preferably, the geometrical shape of the base of the male attachment elements 121 is identical to the geometrical shape of the bases of the hollow complex acoustic elements 110. Thus, if the bases of the hollow complex acoustic elements 110 have a hexagonal shape, the base of the male attachment elements 121 will preferably be hexagonal in shape.

In the configuration in which the male attachment elements 121 have a shape similar to that of the hollow complex acoustic elements 110, the female attachment elements 122 can have a flat shape pierced by a through hole allowing a male attachment element 121 to be inserted and retained, as illustrated in FIGS. 2 and 3. Preferably, the male attachment element 121 is inserted into the female attachment element by the application of pressure such that the male attachment element is clamped by the female attachment element. Preferably, the male attachment element is mounted in the female attachment element such that the base of the male attachment element is in contact with the female attachment element.

According to a variant illustrated in FIG. 4, in the configuration in which the male attachment elements 123 have a shape similar to that of the hollow complex acoustic elements 110, the female attachment elements 124 can also have a shape similar to that of the hollow complex acoustic elements 110, i.e., the female attachment elements 124 have a pierced shape that steadily narrows between a base and a vertex, the base of the female attachment elements 124 being located on the same side of the annular sector as the bases of the hollow complex acoustic elements 110 and the vertex of the female attachment elements 124 being located on the same side as the vertices of the hollow complex acoustic elements 110. Thus, the male attachment element 123 is mounted in the female attachment element 124 such that the base of the male attachment element 123 is in contact with the base of the female attachment element 124, the shape of the female attachment element 124 clamping the shape of the male attachment element 123 between the base and the vertex of the male attachment element 123.

According to another variant illustrated in FIG. 5, the assembly of the male attachment element 125 with the female attachment element 126 is of the snap fastener type.

Naturally, it does not exceed the scope of the invention if other male/female attachment methods are used.

In all configurations, the assembly of the male attachment element with the female attachment element has a dimension along the thickness direction Dₑ less than or equal to the dimension of the other hollow complex acoustic elements 110 along the thickness direction Dₑ. In particular, the assembly of the male attachment element with the female attachment element does not pass through the surface formed by the bases or edges of the hollow complex acoustic elements. The assembly of the male attachment element with the female attachment element is present in a volume comprised between the surface defined by the bases or edges of the hollow complex acoustic elements and the surface defined by the vertices of the hollow complex acoustic elements.

Preferably, as illustrated in FIGS. 2 and 3, all the male attachment elements 121 of the annular sector 100 are located on the second assembly edge 102a and all the female attachment elements 122 of the annular sector 100 are located on the first assembly edge 101a, in order to facilitate the manufacture of the annular sector 100 and the assembly of said sector 100 with the adjacent sectors of multi-element acoustic components.

However, it does not exceed the scope of the invention when the first assembly edge comprises male and female attachment elements, the second assembly edge then also having female attachment elements on the second rows where the first edge comprises a male attachment element and male attachment elements for the second rows where the first edge comprises a female attachment element.

Preferably, a second row of hollow acoustic elements 110 is not adjacent to another second row of hollow acoustic elements 110, in order to improve the assembly between the annular sectors of the annular multi-element acoustic component 10. Thus, two second rows of hollow acoustic elements 110 of an annular sector 100 are preferably separated by one or more first rows of hollow acoustic elements 110.

In the case of square-based hollow acoustic elements, the squares formed by the hollow acoustic elements are arranged side to side, each side of the squares being oriented along the circumferential direction of assembly D_{c} or along the axial direction Dₐ. Thus, the length L_{c} of an annular sector 100 of a multi-element acoustic component 10 should be understood as the length extending along the circumferential direction of assembly D_{c} between the outer side of a square hollow acoustic element of a first row belonging to the first assembly edge and the outer side of a square hollow acoustic element of the same first row belonging to the second assembly edge.

In the case of circular hollow acoustic elements, the centers of the circles formed by the hollow acoustic elements of the same row are aligned along the circumferential direction of assembly D_{c}. Thus, the length L_{c} of an annular sector 100 of a multi-element acoustic component 10 should be understood as the length extending along the circumferential direction D_{c} between the outer side of a circular hollow acoustic element of a first row belonging to the first assembly edge and the outer side of a circular hollow acoustic element of the same first row belonging to the second assembly edge, said length passing diametrically through the circular hollow acoustic elements of the first row at their center. In addition, the centers of the circles of the circular hollow acoustic elements of at least one row out of two alternatingly are aligned along the axial direction Dₐ.

In the case of hexagonal hollow acoustic elements, as in the examples illustrated in FIGS. 2 to 9, the hexagons formed by the hollow acoustic elements 110 are arranged side to side, the centers of the hexagons of the hollow acoustic elements 110 of the same row being aligned along the circumferential direction of assembly D_{c}. Thus, the length L_{c} of the annular sector 100 of a multi-element acoustic component 10 should be understood as the length extending along the circumferential direction of assembly D_{c} between the outer side of a hexagonal hollow acoustic element 110 of a first row belonging to the first assembly edge 101a extending along the axial direction Dₐ and the outer side of a hexagonal hollow acoustic element 110 of the same first row belonging to the second assembly edge 102a and extending along the axial direction Dₐ, said length passing through the hexagonal hollow acoustic elements 110 of the first row at their center. In addition, the centers of the hexagons of the hollow acoustic elements 110 of at least one row out of two alternatingly are aligned along the axial direction Dₐ.

The assembly of the annular sectors 100 of the multi-element acoustic component along the circumferential direction of assembly D_{c} makes it possible to produce the multi-element acoustic component 10. Preferably, all the annular sectors 100 of the multi-element acoustic component are identical, in order to facilitate the manufacture and assembly of said multi-element acoustic component 10.

By using identical annular sectors 100 for the multi-element acoustic component and having the same number of hollow acoustic elements 110 in each first row as well as one less hollow acoustic element 110 in each second row comprising attachment elements 121 and 122, it is ensured that the assembly edges 101a and 102a of the annular sectors 100 will be complementary.

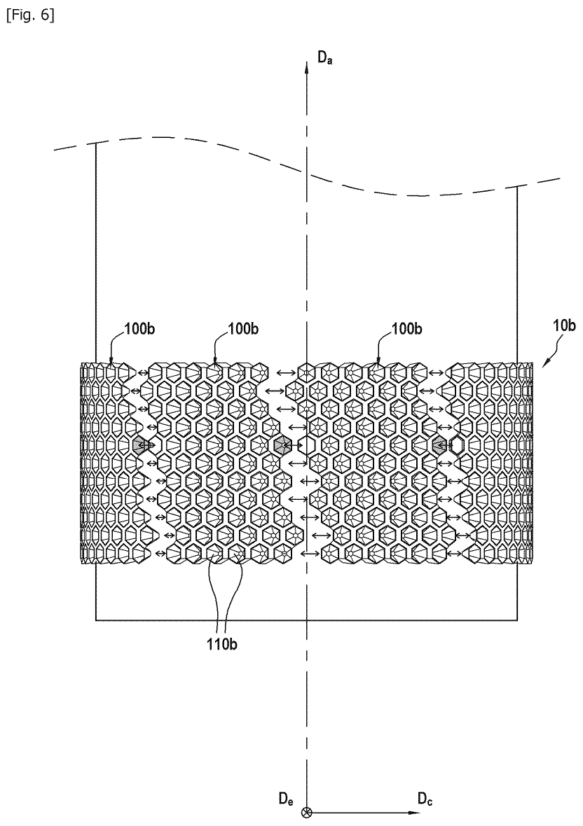

This complementarity property applies even when the rows of hollow complex acoustic elements are irregularly offset with regard to one another, as illustrated in FIG. 6, which illustrates a multi-element acoustic component 10b comprising a plurality of annular sectors 100b comprising hollow complex acoustic elements 110b. In the example illustrated in FIG. 6, the assembly edges of the annular sectors 100b are indeed complementary at their junction.

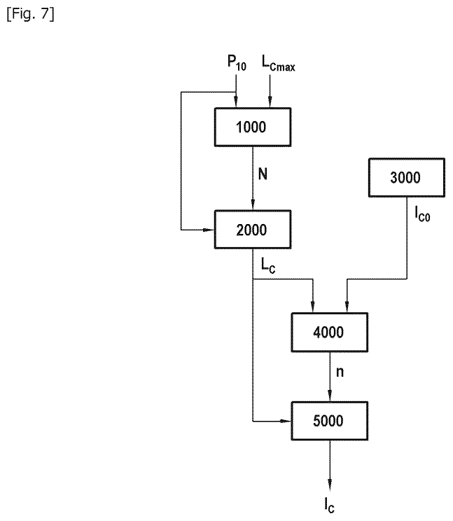

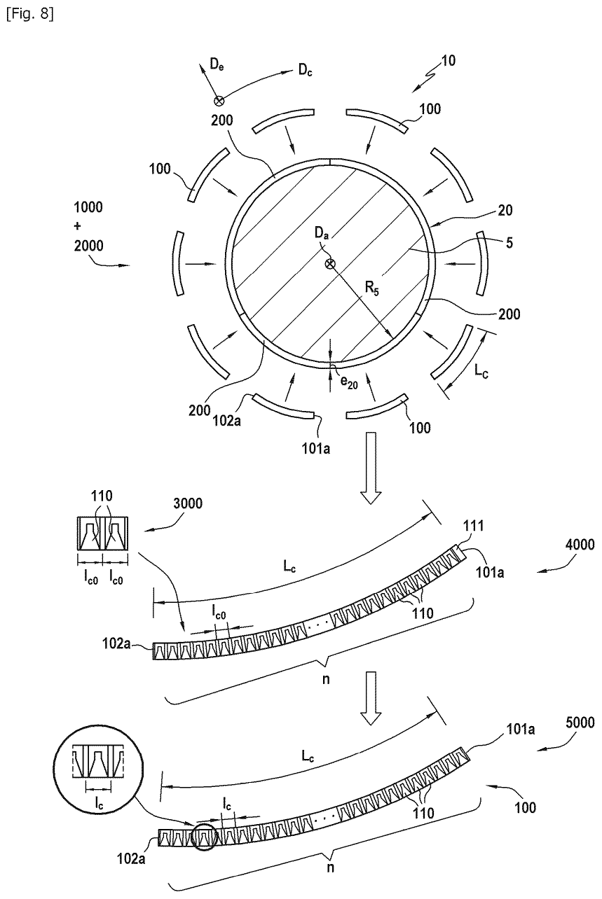

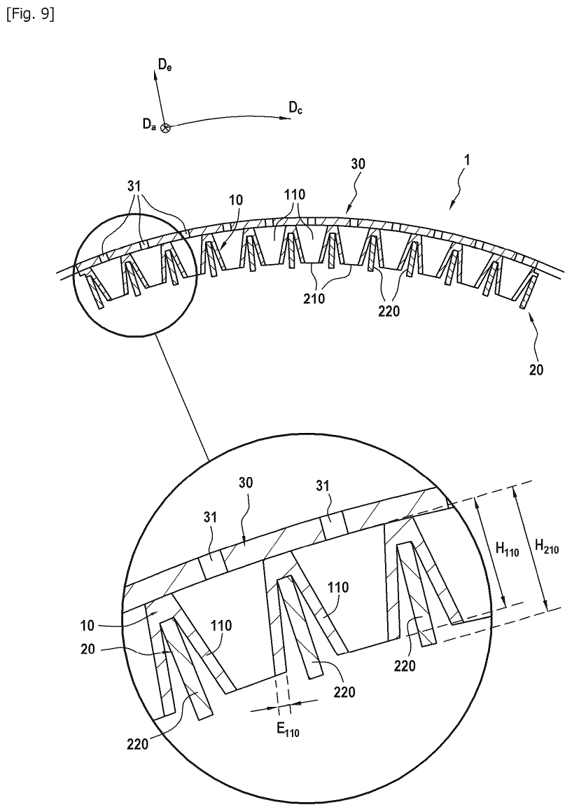

In order to limit the appearance of clearances or overlaps between the annular sectors 100 of the multi-element acoustic component 10, the annular sectors 100 can be designed according to the design method of the invention illustrated in FIGS. 7 and 8.

The multi-element acoustic component 10 is disposed in contact with the multicellular body 20. Thus, the perimeter P₁₀ of the upper surface of the multi-element acoustic component 10 must correspond to the perimeter P₂₀ of the upper surface of the multicellular body 20 in each plane perpendicular to the axial direction Dₐ in order to avoid clearances or overlaps between the annular sectors 100. The perimeter P₁₀ of the upper surface of the multi-element acoustic component 10 corresponds to the sum of the lengths L_{c} of each sector 100 of the multi-element acoustic component 10. The perimeter P₂₀ of the upper surface of the multicellular body 20 is determined in a well-known manner from the perimeter of the surface to be covered of the part 5 and the desired thickness e₂₀ of the multicellular body 20 along the thickness direction Dₑ.

In the example illustrated here, the sectors 100 of the multi-element acoustic component 10 are identical, and all have the same length L_{c} along the circumferential direction of assembly D_{c}.

The first step 1000 of designing the multi-element acoustic component 10 makes it possible to determine the number N of annular sectors 100 that will comprise said multi-element acoustic component 10.

The maximum achievable length L_{cmax} for the annular sectors 100 of the multi-element acoustic component 10 along the circumferential direction of assembly D_{c} is limited and depends on the manufacturing method used to manufacture said annular sectors 100. The annular sectors 100 can be made in a well-known manner by injection molding or by stamping, preferably at controlled temperature and pressure.

Thus, the length L_{c} of the annular sectors 100 is less than or equal to the maximum achievable length L_{cmax} imposed by the manufacturing means. However, in order to limit the number N of annular sectors 100 to be assembled and reduce the number of attachment elements 121 and 122 necessary, it is desired that the length L_{c} of the annular sectors 100 is as close as possible to the maximum achievable length L_{cmax}.

As a result, the number N of sectors 100 of the multi-element acoustic component 10 is determined by rounding to the next integer the ratio of the perimeter P₁₀ of the upper surface of the multi-element acoustic component 10 to be produced to the maximum achievable length L_{cmax} of an annular sector imposed by the manufacturing means. As a reminder, the perimeter P₁₀ of the upper surface of the multi-element acoustic component 10 corresponds to the perimeter P₂₀ of the upper surface of the multicellular body 20.

For example, if the surface of the part 5 to be covered is a cylindrical surface of revolution of radius R₅=1500 mm and the desired thickness e₂₀ of the multicellular body 20 is 28.6 mm, the perimeter P₂₀ of the upper surface of the multicellular body 20 will be approximately 9600 mm. Thus, the perimeter P₁₀ of the upper surface of the multi-element acoustic component 10 to be produced will be approximately 9600 mm. It is also considered that the maximum achievable length L_{cmax} of an annular sector is 1000 mm. It is thus obtained that the number N of sectors 100 of the multi-element acoustic component 10 will be equal to 10.

The numerical values given here and below, in connection with the description of FIG. 7, are given only by way of illustration, in order to better understand the advantages of the design method of the invention. They should not be considered as limiting the invention.

According to the second step 2000 of designing the annular acoustic structure 10, the length L_{c} of each of the N annular sectors 100 is determined by dividing the perimeter P₁₀ of the upper surface of the multi-element acoustic component 10 to be produced by the number N of sectors 100. In our example, a length L_{c} equal to 960 mm is thus obtained.

The third step 3000 of designing the multi-element acoustic component 10 makes it possible to determine a theoretical width I_{c0} of each hollow complex acoustic element along the circumferential direction of assembly D_{c}. This theoretical width I_{c0} corresponds to a theoretical width allowing an optimal reduction of the acoustic waves to be attenuated, especially with regard to a given frequency range. This theoretical width I_{c0} can be determined by an acoustic study carried out independently of the method described here.

The theoretical width I_{c0} of a hollow acoustic element corresponds to the distance extending in the circumferential direction of assembly D_{c} from the middle of the edge separating the hollow acoustic element from a first adjacent hollow acoustic element of the same row to the middle of the edge separating the hollow acoustic element from the second adjacent hollow acoustic element of the same row.

In our example, the theoretical width I_{c0} of the hollow acoustic elements 110 along the circumferential direction of assembly D_{c} is estimated to be 20 mm.

The third step 3000 can be carried out independently of the first and second steps 1000 and 2000. For example, the first and second steps 1000 and 2000 can also be carried out in parallel with the third step 3000.

The fourth step 4000 of designing the multi-element acoustic component 10 makes it possible to determine a whole number n of hollow acoustic elements 110 in each first row of each annular sector 100. This number n is obtained by rounding to the nearest unit the ratio of the length L_{c} of the circumferential edges 101c and 102c to the theoretical width I_{c0} of the hollow acoustic elements 110.

In our example, each annular sector 100 has a length L_{c} of 960 mm and the theoretical width I_{c0} is estimated at 18 mm. Thus, a number n of 53 hollow complex acoustic elements 110 is obtained in each first row, or a number of 52 hollow complex acoustic elements 110 in each second row comprising male and female attachment elements 121 and 122.

As illustrated in FIG. 8, it can be seen that, at the end of the fourth step 4000, the length of the set of n hollow complex acoustic elements 110 of a first row can be different from the length L_{c} of the circumferential edges 101c and 102c. In our example, it can be seen that there remains a lost space 111 of approximately 6 mm, as illustrated in FIG. 8.

In our example, the 53 hollow complex acoustic elements 110 have a theoretical width I_{c0} of 18 mm. Thus, the set of n hollow complex acoustic elements 110 of a first row has a length of 954 mm, or a distance of 6 mm from the length L_{c} of 960 mm. On the scale of the multi-element acoustic component 10 which comprises ten annular sectors 100, these ten lost spaces 111 of approximately 6 mm represent a total lost space of about 60 mm in the circumferential direction D_{c}.

The design method proposed by the invention aims to reduce this lost space, in order to increase the functional surface of the annular acoustic structure 1 and to make it possible to assemble the multi-element acoustic component 10 more easily and cheaply.

Thus, the fifth step 5000 of designing the multi-element acoustic component 10 makes it possible to determine a final width I_{c} of the hollow complex acoustic elements 110 along the circumferential direction of assembly D_{c}.

This final width I_{c} is obtained by dividing the length L_{c} of the circumferential edges 101c and 102c by the number n of hollow complex acoustic elements 110 of each first row of the sectors 100.

The final width I_{c0} of a hollow acoustic element corresponds to the distance extending along the circumferential direction of assembly D_{c} from the middle of the edge separating the hollow acoustic element from a first adjacent hollow acoustic element of the same row to the middle of the edge separating the hollow acoustic element from the second adjacent hollow acoustic element of the same row.

In our example, each annular sector 100 has a length L_{c} of 960 mm and a number n of 53 hollow complex acoustic elements 110 in a first row. Thus, the final width I_{c} of a hollow acoustic element 110 will be 18.1 mm, or an increase of 0.1 mm with respect to the theoretical width I_{c0}. The difference in width between the theoretical width I_{c0} and the final width I_{c} of the hollow complex acoustic elements 110 is not high enough to cause a significant reduction in the acoustic performance of the acoustic structure 1. In return, this difference allows a clear improvement in the assembly of the multi-element acoustic component 10 and an improvement in the area and continuity of the functional surface of the acoustic structure 1.

By using the design method described above, identical annular sectors 100 are produced allowing a very satisfactory assembly of the multi-element acoustic component 10 in the multicellular body 20 around the part 5. The design of identical annular sectors facilitates their manufacture and reduces the associated design and manufacturing costs.

The design and manufacture of the multicellular body 20 are less restrictive than the design and manufacture of the multi-element acoustic component 10. Thus, it is preferable to first design the multi-element acoustic component 10, which then makes it possible to determine the number and dimensions of the cells 210 of the multicellular body 20, so that each hollow complex acoustic element 110 and each female attachment element 122 corresponds to a cell 210 of the multicellular body 20.

Preferably, the multicellular body 20 is also assembled in sectors 200 on the surface to be covered of the part 5, as illustrated in FIG. 8. Since there are fewer manufacturing constraints for the multicellular body 20, large sectors 200 of multicellular body 20 are preferably produced in order to use a limited number of sectors 200 of multicellular body 20. Thus, preferably, the length of the annular sectors 200 of the multicellular body 20 along the circumferential direction of assembly D_{c} is greater than the length L_{c} of the annular sectors 100 of the multi-element acoustic component 10.

When the design of the acoustic structure 1 is complete, the acoustic structure 1 can then be manufactured.

The array of partitions 220 of the multicellular body 20 and the sectors 100 of the multi-element acoustic component 10 can be produced by injection of a filled or unfilled thermoplastic or thermosetting material, by injection-compression of a filled or unfilled thermoplastic or thermosetting material, or by injection with control of the temperature of the tooling of a filled or unfilled thermoplastic or thermosetting material. The acoustic skin 30 can be produced by manual or automatic draping of a composite material with a thermoplastic or thermosetting matrix.

The thermoplastic material used to manufacture the sectors 100 of the multi-element acoustic component 10 or the array of partitions 220 of the multicellular body 20 may especially but not exclusively be selected from the following materials: polyaryletherketones (PAEK) such as polyetheretherketone (PEEK) and polyetherketoneketone (PEKK), polyetherimides (PEI), polycarbonate (PC), polyphenylene sulfide (PPS) and polysulfones (PSU). The thermoplastic material may or may not be filled.

The array of partitions 220 of the multicellular body 20 can also be obtained by using a honeycomb structure, for example made of aluminum or Nomex®.

The sectors 100 of the multi-element acoustic component 10 or the array of partitions 220 of the multicellular body 20 can be made directly by being curved in the circumferential direction of assembly Dc, or can be curved after manufacture, for example by hand or by performing a hot shaping operation. Thin complex acoustic elements are more easily deformable than thick acoustic elements.

Still in the example described here, the sectors 100 of the multi-element acoustic component 10 can be assembled with the multicellular body 20 by bonding or welding. The assembly between the sectors 100 of the multi-element acoustic component 10 and the multicellular body 20 is greatly facilitated by the self-positioning of the complex acoustic elements 110 with the partitions 220 of the multicellular body 20.

The acoustic skin 30 can be fixed by gluing or welding to the upper portion of the bases of the complex acoustic elements 110.

Once assembled, the acoustic structure 1 comprises a plurality of complete acoustic cells each formed by a complex acoustic element 110 and the partitions 220 of the multicellular body 20 surrounding it, as illustrated in FIG. 9.

The height H₁₁₀ of the complex acoustic elements 110 is less than the height H₂₁₀ of the cells 210 of the multicellular body 20. More precisely, the height H₁₁₀ of the hollow acoustic elements 110 is comprised between 10% and 99% of the height H₂₁₀ of the cells 210 along the thickness direction Dₑ. The height H₁₁₀ may be comprised between 5 mm and 100 mm while the base of each hollow acoustic element 110 may be inscribed in a circle of diameter comprised between 5 mm and 50 mm. In addition, the hollow complex acoustic elements 110 have a very small thickness E₁₁₀, less than 1 mm and typically between 0.3 mm and 0.5 mm.

Naturally, it does not exceed the scope of the invention if the elements constituting the annular acoustic structure 1 are made according to different processes or with different materials.

The annular acoustic structure, the multi-element acoustic component and its sectors and the multicellular body illustrated in FIGS. 1 to 9 are simplified, and the number of cells or hollow acoustic elements per row or per sector may vary or be reduced for reasons of simplification of the figures.

The expression “comprised between” should be understood to include the bounds.

1. An annular sector of an annular multi-element acoustic component extending along a direction of assembly between a first assembly edge and a second assembly edge opposite the first assembly edge, the annular sector comprising:
a plurality of rows of hollow complex acoustic elements each having a shape that steadily narrows between a base and a vertex, the hollow complex elements being connected to each other by one or more adjacent edges, each row extending from the first to the second assembly edge along the direction of assembly, and
a plurality of first rows comprising the same number of hollow complex acoustic elements and one or more second rows comprising one less hollow complex element than the first rows, each second row further comprising a male attachment element on one of the assembly edges and a female attachment element on the other assembly edge, the female attachment element having the same dimension as a hollow complex element along the direction of assembly.

2. The annular sector of the multi-element acoustic component according to claim 1, wherein the male attachment element has a pierced shape that steadily narrows between a base and a vertex.

3. The annular sector of a multi-element acoustic component according to claim 1, wherein the bases of the hollow complex acoustic elements are hexagonal.

4. An annular multi-element acoustic component comprising assembling a plurality of annular sectors according to claim 1 along the direction of assembly, each male attachment element of an annular sector of the acoustic component being inserted into a female attachment element of an adjacent sector.

5. The multi-element acoustic component according to claim 4, wherein all the sectors are identical.

6. An annular acoustic attenuation structure comprising an annular multi-element acoustic component according to claim 4 and an annular multicellular body, the vertex of each hollow complex acoustic element of the multi-element acoustic component being inserted into a cell of the multicellular body.

7. The annular acoustic attenuation structure according to claim 6, said annular acoustic attenuation structure further comprising a perforated acoustic skin, said acoustic skin being in contact with the base of the hollow complex acoustic elements.

8. The annular acoustic attenuation structure according to claim 6, wherein the annular multicellular body comprises a plurality of annular sectors of assembled multicellular bodies extending along the direction of assembly, a length of the annular sectors of the multicellular body being greater than a length of the annular sectors of the multi-element acoustic component along the direction of assembly.

9. A method of manufacturing an annular multi-element acoustic component comprising the assembly of a plurality of annular sectors along a direction of assembly, each annular sector extending along the direction of assembly between a first assembly edge and a second assembly edge opposite the first assembly edge, each annular sector comprising a plurality of rows of hollow complex acoustic elements each having a shape that narrows steadily between a base and a vertex, the hollow complex elements being connected each other by one or more adjacent edges, each row extending from the first to the second assembly edge along the direction of assembly, each annular sector comprising a plurality of first rows comprising the same number of hollow complex elements and one or more second rows comprising one less hollow complex element than the first rows, each second row further comprising a male attachment element on one of the assembly edges and a female attachment element on the other assembly edge, the female attachment element having the same dimension as a hollow complex element along the direction of assembly, all the annular sectors being identical, the multi-element acoustic component extending around an axial direction and having a defined inner or outer cross-sectional perimeter, each annular sector of the acoustic component extending along the axial direction between a first circumferential edge and a second circumferential edge, the circumferential edges extending along the direction of assembly, the method comprising:
determining a number of annular sectors of the multi-element acoustic component by rounding to the next integer the ratio of the perimeter of the cross-section of said acoustic component to a maximum theoretical length of an annular sector of a multi-element acoustic component;
determining a length of the circumferential edges of each annular sector of the acoustic component;
determining a theoretical width along the direction of assembly of the hollow complex acoustic elements corresponding to the desired acoustic attenuation;
determining a whole number of hollow complex acoustic elements per first row of each annular sector;
determining a final width along the direction of assembly of the hollow complex acoustic elements; then
manufacturing the annular sectors of said multi-element acoustic component in accordance with the determined number of annular sectors, the determined length of the circumferential edges, the whole number of hollow complex acoustic elements per determined first row and the final width along the determined assembly direction of the hollow complex acoustic elements, and
assembling the annular sectors of the multi-element acoustic component with each other along the direction of assembly by inserting each male attachment element of an annular sector into a female attachment element of an adjacent annular sector.

10. A method of manufacturing an annular acoustic attenuation structure comprising:
manufacturing an annular multi-element acoustic component according to the method of claim 9, the annular sectors of the multi-element acoustic component being assembled with an annular multicellular body, so that each hollow complex acoustic element is arranged in a cell of the multicellular body; and
covering the multi-element acoustic component with an acoustic skin so as to form the annular acoustic attenuation structure comprising at least the annular multi-element acoustic component, the annular multicellular body and the acoustic skin.
